(19) United States
(12) Patent Application Publication
(10) Pub. No.: US 2010/0265397 A1
(43) Pub. Date: Oct. 21, 2010

(54) SYSTEMS AND METHODS FOR PROVIDING DYNAMICALLY DETERMINED CLOSED CAPTION TRANSLATIONS FOR VOD CONTENT

(75) Inventors: Charles Dasher, Lawrenceville, GA (US); Alan Rouse, Lawrenceville, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tandberg Television, Inc.

(21) Appl. No.: 12/426,526

(22) Filed: Apr. 20, 2009

(51) Int. Cl. H04N 7/00; H04N 7/173

(52) U.S. Cl. 348/468; 725/87; 348/E07.001

(57) ABSTRACT

Various embodiments of the present invention provide systems and methods for providing dynamically determined closed caption translations for video on demand (VOD) content. In particular embodiments, the systems and methods deliver a video program selected by a viewer from a VOD service over a unicast stream in a preferred language identified by the viewer. In addition, in particular embodiments, the systems and methods deliver the video program over the unicast stream along with a voice track in the viewer's preferred language.

### BACKGROUND OF THE INVENTION

1. Field of the Invention

The disclosed invention generally relates to systems and methods for providing dynamically determined closed caption translations for video on demand (VOD) content, and more specifically, to systems and methods for providing a closed caption translation in a preferred language for a video program selected by a viewer.

2. Description of the Related Art

Today, many cable and satellite TV providers offer a wide range of products and services to their customers. One such service is video on demand (VOD) programming or audio video on demand (AVOD) that allow subscribers to select and watch/listen to video and/or audio content on demand. A subscriber is provided with a listing of VOD content and the subscriber selects particular content (such as a movie, television program, or music program), and the VOD service (system) streams the content through the subscriber's set-top box for viewing/listening.

Typically, many video programs provided over a VOD service include closed caption text in an alternate language other than the language used for the audio track. That is, if the audio track for a selected video program is provided in English and the viewer of the selected video only understands French, the viewer may wish to view closed caption text in French. In most cases, only one closed caption option is offered for any one video program. For example, the viewer may have the option of viewing closed caption text in Spanish for the available video programs in the VOD service provided by the viewer's cable or satellite TV provider. The service provider may have selected to provide closed caption for this particular language based on the demographics of the area the provider is servicing with the closed caption text.

However, in many cases there will still be a number of viewers (e.g., subscribers or potential subscribers) whose primary language is not English or Spanish. In these cases, such a viewer may be unable to fully enjoy video programming provided via the VOD service because he or she has difficulty understanding what is being said in any selected video program. Thus, a need exists for a mechanism by which such a viewer can select a preferred language from a substantial number of languages and a selected video program is streamed to the viewer that includes closed caption text in the viewer's preferred language.

### BRIEF DESCRIPTION OF THE DRAWINGS

Having thus described various embodiments of the invention in general terms, reference will now be made to the accompanying drawings, which are not necessarily drawn to scale, and wherein:

FIG. 1 is a flow diagram illustrating the process for providing a selected video program from a VOD service in a preferred language according to various embodiments of the invention.

FIG. 2 is a schematic diagram illustrating a cable provider's system according to various embodiments of the invention.

FIG. 3 is a schematic diagram illustrating a set-top box residing in the system shown in FIG. 1 according to various embodiments of the invention.

FIG. 4 is a schematic diagram illustrating a VOD application server residing in the system shown in FIG. 1 according to various embodiments of the invention.

FIG. 5 is a flow diagram of a VOD client module according to various embodiments of the invention.

FIG. 6 illustrates screens provided in a VOD service according to various embodiments of the invention.

FIG. 7 is a flow diagram of a closed caption translation module according to various embodiments of the invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Like numbers refer to like elements throughout.

As should be appreciated, the embodiments may be implemented in various ways, including as methods, apparatus, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### BRIEF OVERVIEW OF AN EMBODIMENT

Various embodiments of the present invention provide systems and methods for providing dynamically determined closed caption translations for video on demand (VOD) content. For example, various embodiments of the present invention provide systems and methods for delivering a video program selected by a viewer from a VOD service in a preferred language over a unicast stream. The term “provider” is used from this point forward to indicate a cable service provider or a satellite TV provider or any other provider of distributed video media content.

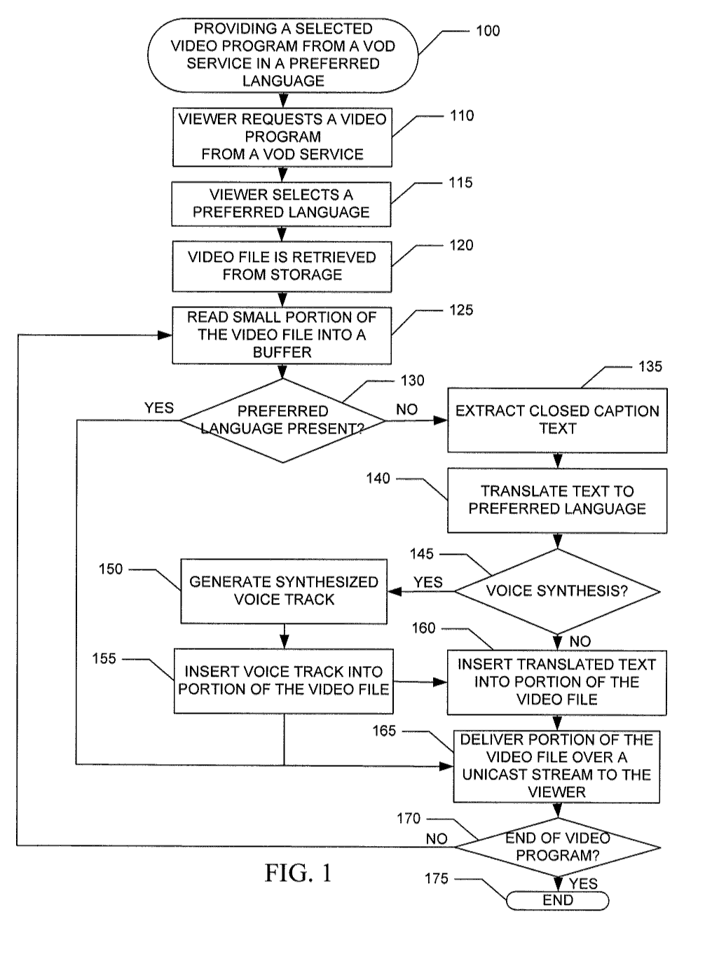

FIG. 1 illustrates a flow diagram of a process 100 for providing a selected video program from a VOD service in a viewer's preferred language according to an embodiment of the invention. The process begins at Step 110 with the viewer selecting the provider's VOD service on the user's television and requesting a particular video program to view. For instance, the user selects a button on the user's remote control signaling the set-top box to bring up one or more menus for such service. The viewer then navigates through the menus using the remote control to view the video programs available through the VOD service and requests the particular video program by selecting one or more buttons on the remote control.

At Step 115, the viewer may also select a preferred language in which closed caption text is provided in the particular video program. For instance, in one embodiment, the viewer selects a particular language from a menu provided with the VOD service at the time the viewer selects the particular video program by using his or her remote control. While in another embodiment, the viewer sets a particular language as the preferred language in a setup menu for the VOD service and this selection of preferred language is stored either locally and/or remotely. In this particular embodiment, each time the viewer requests a video program to watch, the viewer's preferred language is retrieved and the program is streamed to the viewer with closed caption text in the viewer's preferred language. In addition, in various embodiments, the viewer may indicate whether he or she would like to receive closed caption text in the viewer's preferred language and/or a voice track in the viewer's preferred language.

The process 100 continues with the viewer's request for the video program and an identifier of the viewer's preferred language being sent to the head-end of the provider's system. For instance, the viewer's set-top box sends the viewer's request and preferred language identifier over a network to the head-end of the provider's system. In a particular embodiment, the head-end directs the viewer's request to a VOD application server located on the system and the server retrieves a video file for the particular video program from storage, shown as Step 120. In various embodiments, the video file may be of various file types such as an MPEG file.

In Step 125, the process 100 continues with at least a subset of the portion of the video file being read into memory to be streamed over the network to the viewer's set-top box. For example, the VOD application server reads the portion of the video file and saves the portion in a buffer (e.g., local memory on the server). In various embodiments, the amount of the video file that is read is sufficient to determine what languages are present in the video file and to reach the first closed caption text to be translated.

In Step 130, a determination is made as to whether the viewer's preferred language is already present as closed caption text in the video file. In one particular embodiment, this determination is based on the language identifier that was sent along with the request from the viewer's set-top box. In another embodiment, the language identifier is retrieved from a profile stored in the provider's system for the particular viewer and the determination is based on the retrieved identifier.

If the preferred language is already present, the process 100 continues with simply delivering the portion of the video file over a unicast stream to the viewer's set-top box, shown as Step 165. The set-top box receives the stream and provides a signal that is viewed by the viewer on the viewer's television set. Since the video program already has closed caption text in the viewer's preferred language, the viewer is able to watch the program in the viewer's preferred language. In turn, the remainder of the video program is streamed to the viewer in a similar fashion.

If the viewer's preferred language is not present, the process 100 continues with extracting the closed caption text (e.g., closed caption data) from at least a subset of the portion of the video file, shown as Step 135. In one particular embodiment, this step may require optical character recognition (OCR) to be performed if the text has been converted to graphic/raster text. In another embodiment, this step may require extracting the text from an MPEG stream if the text has been stored in conventional text form.

Continuing with Step 140, the text is translated into the viewer's preferred language using one or more available text translation components. For example, the provider's system may incorporate translation software, such as Babylon®, Systran®, or Promt®. As a result, the closed caption text is translated into the viewer's preferred language and in an appropriate character set for the language.

In various embodiments, the provider's system may also be configured to provide a voice track of the translated closed caption text to the viewer. Therefore, in these particular embodiments, the viewer can also listen to the video program in the viewer's preferred language. In Step 145 of these particular embodiments, a determination is made as to whether voice synthesis of the translated closed caption text is required. For instance, in one embodiment, the set-top box also sends an identifier to the system head-end that indicates to provide a voice track in the viewer's preferred language. In another embodiment, the viewer's profile may indicate to provide the voice track.

Thus, if the determination is made to provide the voice track, the process 100 continues with generating the synthesized voice track for the translated closed caption text, shown as Step 150. As in the case with translating the closed caption text, the provider's system may incorporate any number of text-to-voice synthesizer components, such as the Oki Semiconductor® MSM7630 processor. In various embodiments, the text-to-voice synthesizer component produces the voice track as digital audio data. For example, in particular embodiments, the text-to-voice synthesizer component produces the voice track as either MPEG audio data or AC3 audio data. Finally, in Step 155, the voice track is inserted into the portion of the video file (e.g., the existing voice track is replaced with the translation voice track).

Furthermore, in Step 160, the process 100 may include inserting the translated closed caption text into the portion of video file stored in the buffer. In one embodiment, the VOD application server may perform this step after determining not to provide a voice track for the translated closed caption text. In another embodiment, the server may insert the translated closed caption text in addition to the voice track. In another embodiment, the server may not insert the translated closed caption text at all and only include the voice track.

In Step 165, the process 100 continues with delivering the portion of the video file that includes the translated closed caption text and/or the voice track in the viewer's preferred language over a unicast stream from the provider's system to the viewer's set-top box over a distribution network. Thus, the viewer's set-top box receives the stream and provides a signal based on the portion of the video file to the viewer's television set so that the viewer can watch the video program. In the embodiments in which the translated closed caption text has been inserted, the viewer is able to watch the program with closed caption text in the viewer's preferred language. In the embodiments in which the voice track has been inserted, the viewer is able to watch the program and listen to the program in the viewer's preferred language (or both, if the translated closed caption text has also been inserted).

Furthermore, in Step 170, a determination is made as to whether the end of the video program has been reached. For instance, in one embodiment, the VOD application server determines that the entire video program has not been streamed to the viewer's set-top box (e.g., the VOD application server determines that the end of the video file has not been read). Therefore, the VOD application server reads the next portion of the video file and the process 100 returns to Step 125 and the steps are repeated for delivering the next portion of the video file over the unicast stream to the user's set-top box with translated closed caption text in the viewer's preferred language and/or a voice track in the user's preferred language. These steps are repeated until the end of the video file is reached and the process 100 ends, shown as Step 175. As a result of this process 100, the viewer is able to watch the entire video program in the viewer's preferred language.

### System Architecture

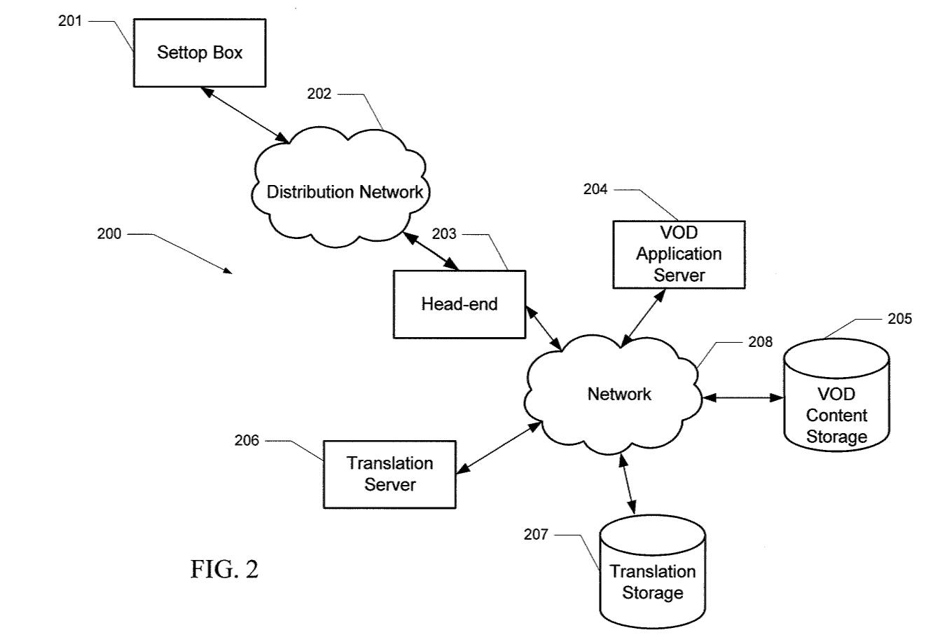

A media content providing system 200 according to various embodiments of the invention is shown in FIG. 2. For instance, the system 200 may be a cable provider's system 200 providing cable programming to the cable provider's subscribers. However, the system 200 may also be a satellite TV provider's system or an Internet provider's system. Therefore, the system 200 depicted in FIG. 2 is provided for illustrative purposes only and should not be construed to limited the scope of the claimed invention.

As may be understood from this figure, in various embodiments, the system 200 includes a set-top box 201. The set-top box 201 is a device that is used by an individual to receive a digital cable signal for a television and is configured to send data to the head-end 203 of the system 200. For example, the set-top box 201 may be a device, such as a personal video recorder (PVR) provided by a cable company. The PVR receives the digital cable signal and feeds the signal into an individual's television set so that the individual can view the cable company's cable television programming.

However, the set-top box 201 does not necessary need to be a digital cable box for a television. For instance, in other embodiments, the set-top box 201 may be a computing device, such as an individual's desktop computer or laptop computer, configured to receive media signals over a network.

In various embodiments, the set-top box 201 communicates with the head-end 203 of the system 200 over a distribution network 202. The head-end 203 routes messages (e.g., user input) to various components of the provider's system 200 and streams content (e.g., a selected VOD program) to the set-top box 201. For instance, in one embodiment, the head-end 203 receives input from the user via the set-top box 201, interprets the input, and sends the input to the appropriate component of the system 200, such as the VOD application server 204. Other embodiments of the system 200 do not include the head-end 203 and the set-top box 201 routes input directly to the components of the system 200.

In addition, the system 200 of various embodiments may also include a translation server 206. In various embodiments, this server 206 is configured to perform specific functions within the system 200. For instance, as will be described in further detail below, the translation server 206 may include software and/or hardware components configured to provide translations of closed caption text and to provide voice tracks for the translated closed caption text. Furthermore, several of the components of the system 200 are connected via a network 208 within the media content providing system 200 (e.g., a LAN, the Internet, a wireless network, and/or a private network) and communicate with one another.

In addition, as depicted in FIG. 2, the system 200 may also include storage medium, such as VOD content storage 205 and translation storage 207. The storage medium 205, 207 are also connected via the network 208 and communicate with other components of the system 200. In various embodiments, the VOD content storage 205 stores the provider's VOD content and associated information, such as program guides detailing the available VOD content. In various embodiments, the translation storage 207 stores-translations of VOD content in various languages that may be retrieved for use.

In various embodiments, the components 201, 203, 204, 205, 206, 207 may be one or more devices or include one or more devices executing software programs. Furthermore, in various embodiments, the storage medium 205, 207 may be one or more types of medium such as hard disks, magnetic tapes, or flash memory.

### Exemplary Set-Top Box

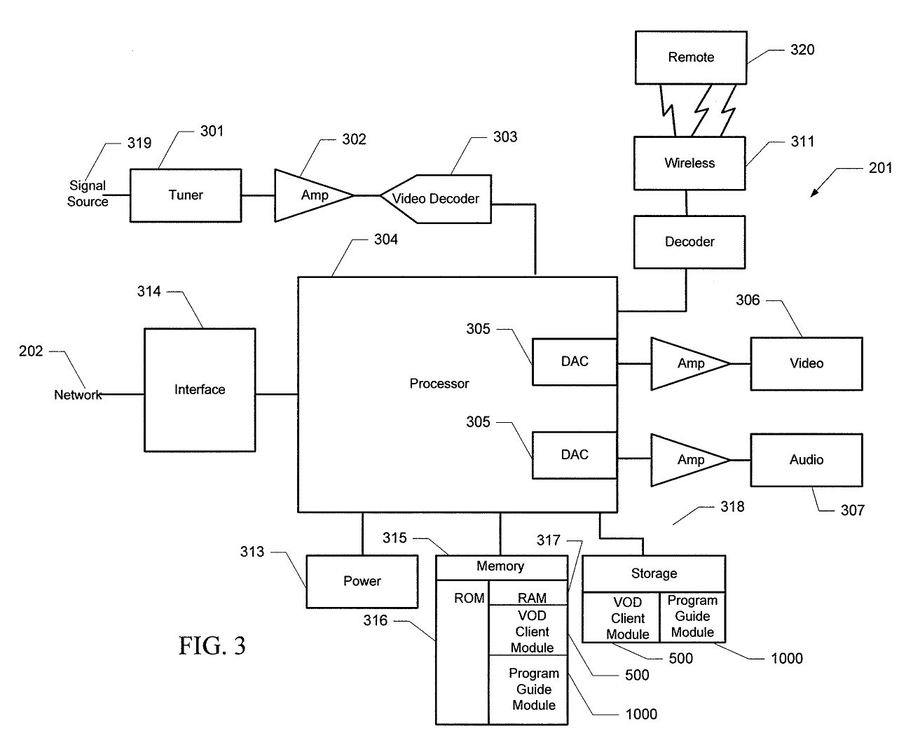

FIG. 3 shows a schematic diagram of a set-top box 201 according to one embodiment of the invention. The particular set-top box 201 depicted in FIG. 3 is configured to receive a digital signal from a cable provider or a satellite TV provider and to convert the signal into audiovisual content that is typically displayed on a television. However, as noted above, the set-top box 201 is not limited to a device used to receive a digital signal from a cable company. For example, the set-top box 201 may be a device configured to receive a digital signal from an individual's computing device. Thus, the set-top box 201 depicted in FIG. 3 is for illustrative purposes only, and should not be construed to limit the scope of the invention.

The particular embodiment of the set-top box 201 shown in FIG. 3 includes a processor 304 and storage 318, such as a hard disk drive and/or a flash drive, on which audiovisual data may be recorded and stored by the processor 304. In addition, the set-top box 201 further includes memory 315 composed of both read only memory (ROM) 316 and random access memory (RAM) 317.

The set-top box 201 further includes a tuner 301 configured to receive the incoming source signal 319. The tuner 301 sends the source signal 319 through an amplifier 302 and a video decoder 303 configured to translate the encoded source signal 319 into its original format. The video decoder 303 directs the translated source signal 319 to the processor 304.

In various embodiments, the processor 304 may also include a digital-to-analog converter (DAC) 305, 306 configured to convert the translated source signal 319 from a digital signal to an analog signal if the television will only read an analog signal. Furthermore, the processor 304 is configured to feed the translated signal to the video and audio outputs 306, 307 of the set-top box 201 that are connected to the television.

In addition, the set-top box 201 may also include a wireless interface 311 that is configured to receive commands (and/or input) from a viewer via transmission from a remote control 320. The remote control 320 may transmit such commands using any number of transmitters, such as a radio frequency transmitter, a supersonic transmitter, or an optical transmitter.

A number of program modules may also be stored within the storage 318 and/or within the RAM 217 of the set-top box 201. For example, a VOD client module 500 and a program guide module 1000 may be stored within the storage 318 and/or RAM 317. These modules 500, 1100 may be used to control certain aspects of the operation of the set-top box 201, as is described in more detail below, with the assistance of the processor 304.

Also located within the set-top box 201 is an interface 314, for interfacing and communicating with other elements of a network (such as the components in communication with the network 202 described in the media content providing system 200 depicted in FIG. 2.) It will be appreciated by one of ordinary skill in the art that one or more of the set-top box's 201 components may be located geographically remotely from other set-top box 201 components. Furthermore, one or more of the components may be combined, and additional components performing functions described herein may also be included in the set-top box 201.

### Exemplary Server

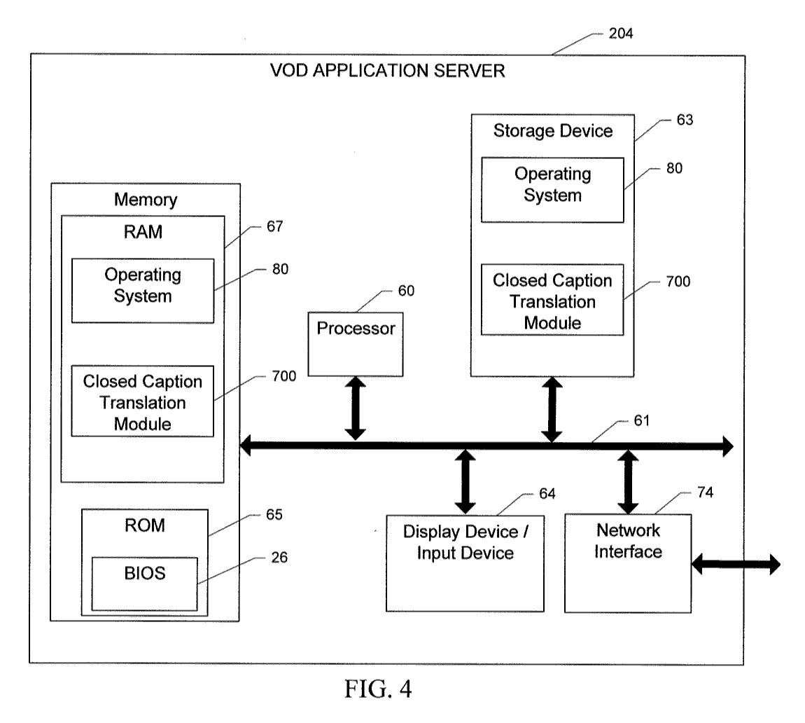

FIG. 4 shows a schematic diagram of one of the servers in the media content providing system 200 depicted in FIG. 2 according to one embodiment of the invention. For example, the server may be the routing server 203, the VOD application server 204, or the translation server 206 shown in FIG. 2. However, for purposes of illustration, an embodiment of the VOD application server 204 is specifically shown in FIG. 4. Though, in various embodiments, the other servers 203, 206 have a similar structure.

In FIG. 4, the server 204 includes a processor 60 that communicates with other elements within the server 204 via a system interface or bus 61. Also included in the server 204 is a display device/input device 64 for receiving and displaying data that may be used by administrative personnel. This display device/input device 64 may be, for example, a keyboard or pointing device that is used in combination with a monitor. The server 204 further includes memory 66, which preferably includes both read only memory (ROM) 65 and random access memory (RAM) 67. The server's ROM 65 is used to store a basic input/output system 26 (BIOS), containing the basic routines that help to transfer information between elements within the server 204. Alternatively, the server 204 can operate on one computer or on multiple computers that are networked together.

In addition, the server 204 includes at least one storage device 63, such as a hard disk drive, a floppy disk drive, a CD Rom drive, flash drive, or optical disk drive, for storing information on various computer-readable media, such as a hard disk, a removable magnetic disk, or a CD-ROM disk. As will be appreciated by one of ordinary skill in the art, each of these storage devices 63 is connected to the server bus 61 by an appropriate interface. The storage devices 63 and their associated computer-readable media provide nonvolatile storage for the server 204. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. For example, as shown in FIG. 4, program modules of the VOD application server 204 may include an operating system 80 and a closed caption translation module 700. The closed caption translation module 700 may be used to control certain aspects of the operation of the VOD application server 204, as is described in more detail below, with the assistance of the processor 60 and an operating system 80.

Also located within the server 204 is a network interface 74, for interfacing and communicating with other elements of one or more networks (such as the network 208 described in the media content providing system 200 depicted in FIG. 2.) It will be appreciated by one of ordinary skill in the art that one or more of the server's 204 components may be located geographically remotely from other server 204 components. Furthermore, one or more of the components may be combined, and additional components performing functions described herein may be included in the system 200.

### Exemplary System Operation

As previously discussed, in various embodiments, the set-top box 201 includes a VOD client module 500 and a program guide module 1000. The VOD client module 500 is configured to provide VOD service to the user and to request that particular media content be streamed to the user's set-top box 201 for viewing. The program guide module 1000 is configured to provide programming information of available VOD content (e.g., listings of available programming from the provider's VOD service). In various embodiments, the VOD application server 204 includes a closed caption translation module 700. This module 700 is configured to provide various video programs with translated closed caption text and/or translated voice tracks that are delivered to the user's set-top box 201 for viewing. Furthermore, in various embodiments, the closed caption translation module 700 may communicate with a translation server 206 that includes one or more components configured to perform a translation on extracted closed caption text and one or more components configured to synthesize a voice track from translated closed caption text. These modules 500, 700, 1000 and components are described in more detail below.

### VOD Client Module

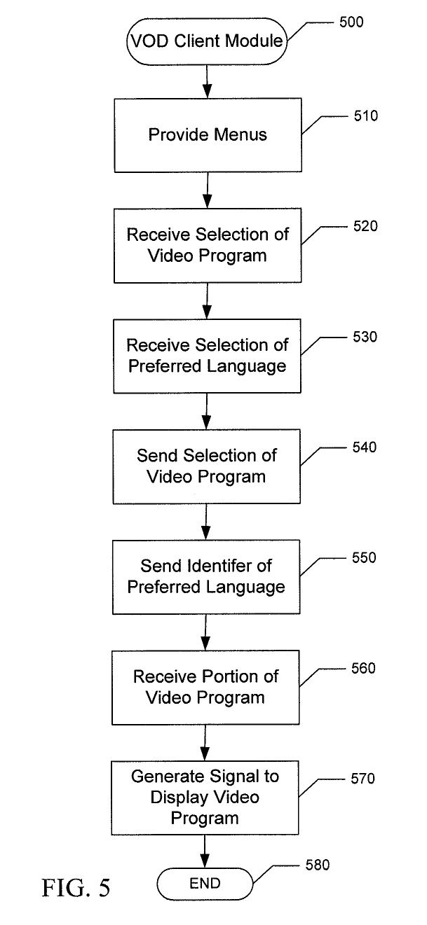

In various embodiments, the user's set-top box 201 may include a VOD client module 500 that is configured to implement VOD service on the user's set-top box 201. Accordingly, FIG. 5 illustrates a flow diagram of a VOD client module 500 according to various embodiments. This flow diagram may correspond to the steps carried out by the processor 304 in the set-top box 201 shown in FIG. 3 as it executes the module 500 in the box's 201 RAM memory 317 according to various embodiments.

In various embodiments, the viewer may request to bring up the VOD service on the viewer's television screen. Thus, in Step 510, the VOD client module 500 provides screens for prompting the viewer for input (e.g., menus) that the viewer may used to navigate the VOD service. For example, in one embodiment, the VOD client module 500 requests programming information from the program guide module 1000 and the program guide module 1000 sends information on available VOD content to the VOD client module 500 to display to the viewer. The viewer may peruse the available VOD content and select a particular video program for viewing. For instance, the viewer may use his or her remote control to navigate through the various menus of the VOD service and select a particular program by pressing one or more buttons on the remote control. Thus, in Step 520, the VOD client module 500 receives the viewer's selection of a video program.

In addition, in various embodiments, the viewer may not understand the language for which the program is provided. For example, the viewer's primary language may be Portuguese and the selected video program is provided in English. In many traditional VOD services, the service (and/or particular video program) may provide a closed caption option in an alternative language. For instance, the VOD service may provide closed caption text in Spanish. However, such an option does not help viewers who do not understand Spanish.

Thus, in various embodiments of the invention, the viewer also indicates what language he or she prefers to receive closed caption text in. For instance, in various embodiments, the viewer selects the preferred language from a number of languages provided on one or more menus of the VOD service. Therefore, the viewer scrolls through the list of available languages using his or her remote control and selects a preferred language. In one embodiment, the viewer selects the preferred language at the same time the viewer selects the video program to watch. In another embodiment, the viewer selects a preferred language that is stored either locally on the viewer's set-top box 201 or remotely on the provider's system 200 in a profile associated with the viewer. Therefore, each time the viewer selects a particular video program to watch, the viewer's preferred language is retrieved from the viewer's profile and the program is provided to the viewer with closed caption text in the viewer's preferred language. Thus, in various embodiments, the VOD client module 500 receives the viewer's selection of a preferred language, shown as Step 530.

In various embodiments, the VOD client module 500 sends the viewer's selection of video program and an identifier of the viewer's preferred language over the distribution network 202 to the head-end 203 of the provider's system, shown as Steps 540 and 550. In various embodiments, the head-end 203 routes the selection and identifier to the VOD application server 204 located within the system 200, and the VOD application server 204 retrieves a video file for the particular program from a storage medium. For example, the VOD application server 204 retrieves the video file from the VOD content storage 205 shown in the system 200 depicted in FIG. 2.

As is described in greater detail below, the VOD application server 204 of particular embodiments reads a portion of the video file and extracts the closed caption text located in at least a subset of the portion of the video file to have the text translated into the viewer's preferred language. The VOD application server 204 then inserts the translated closed caption text into the portion of the video file and delivers the portion over a unicast stream to the user's set-top box 201. Thus, in Steps 560 and 570, the VOD client module 500 receives a unicast stream that includes the portion of the video file and generates a signal from the portion to display the video program on the viewer's television.

As a result of the VOD application server 204 inserting the translated closed caption text into the portion of the video file, the viewer is provided with closed caption text in the viewer's preferred language. Thus, in various embodiments, the VOD application server 204 repeats the process of reading portions of the video file, extracting the closed caption text from at least a subset of the portion to have the text translated into the viewer's preferred language, inserting the translation closed caption text into the portion, and delivering the portion to the viewer's set-top box 201 over the unicast stream until the VOD application server 204 reads the end of the program file. At this point the process ends, shown as Step 580. Accordingly, the viewer is able to view the entire video program with closed caption text in the viewer's preferred language.

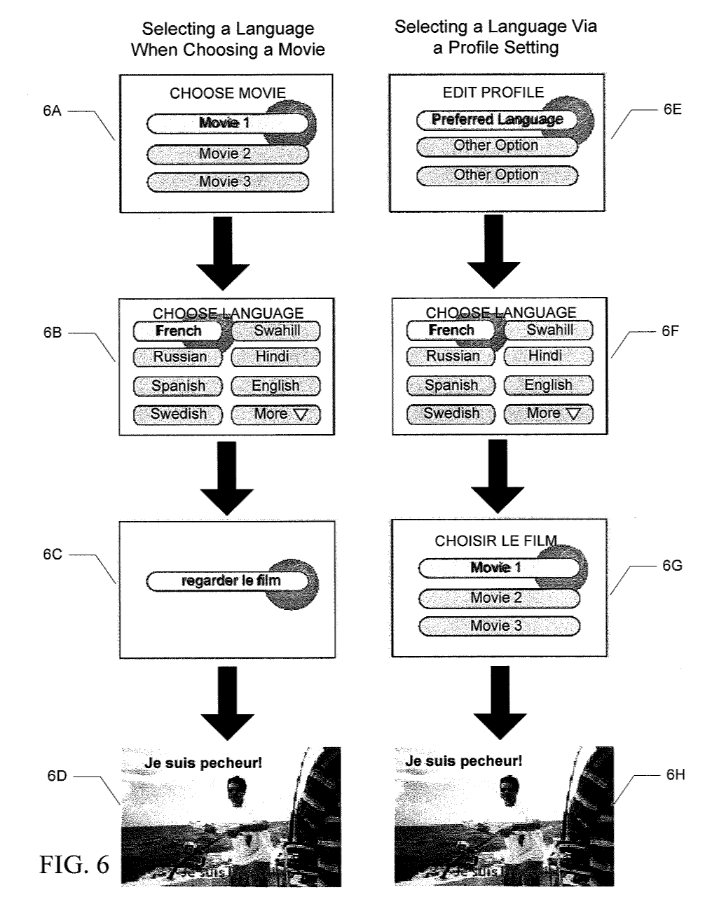

FIG. 6 displays typical screens (e.g., menus) that may be provided in a VOD service according to various embodiments of the invention. Screens 6A-6D provide an example in which the viewer selects his or her preferred language at the time he or she selects the video program to view. In this example, the viewer first selects the video program he or she would like to view on Screen 6A (e.g., the movie Star Wars). Next, the viewer scrolls thru one or more screens of available languages to select a preferred language. In this particular example, the viewer has selected French shown on Screen 6B. As a result, the following screen (e.g., Screen 6C) is shown in French. The viewer selects the button on the screen to watch the selected movie and the movie is streamed to the viewer with closed caption text in French, shown on Screen 6D.

In the second example, Screens 6E-6H provide an example in which the viewer selects a preferred language that is stored in a profile for the viewer. Therefore, in this example, the viewer enters a screen that allows the viewer to edit his or her profile as shown on Screen 6E. The viewer selects to edit his or her preferred language and one or more screens of available languages are shown. The viewer scrolls thru the screens and selects French as his or her preferred language, as shown on Screen 6F. The viewer selection is saved in the viewer's profile. As a result, whenever the viewer enters the VOD service to select a program to watch, the viewer's preferred language is retrieved from the viewer's profile and the provided screens are shown in French. In this example, the viewer enters the screens to select a movie and selects Star Wars, as shown on Screen 6G. In response, the movie is steamed to the viewer with closed caption text in the viewer's preferred language (e.g., French), shown in Screen 6H.

### Closed Caption Translation Module

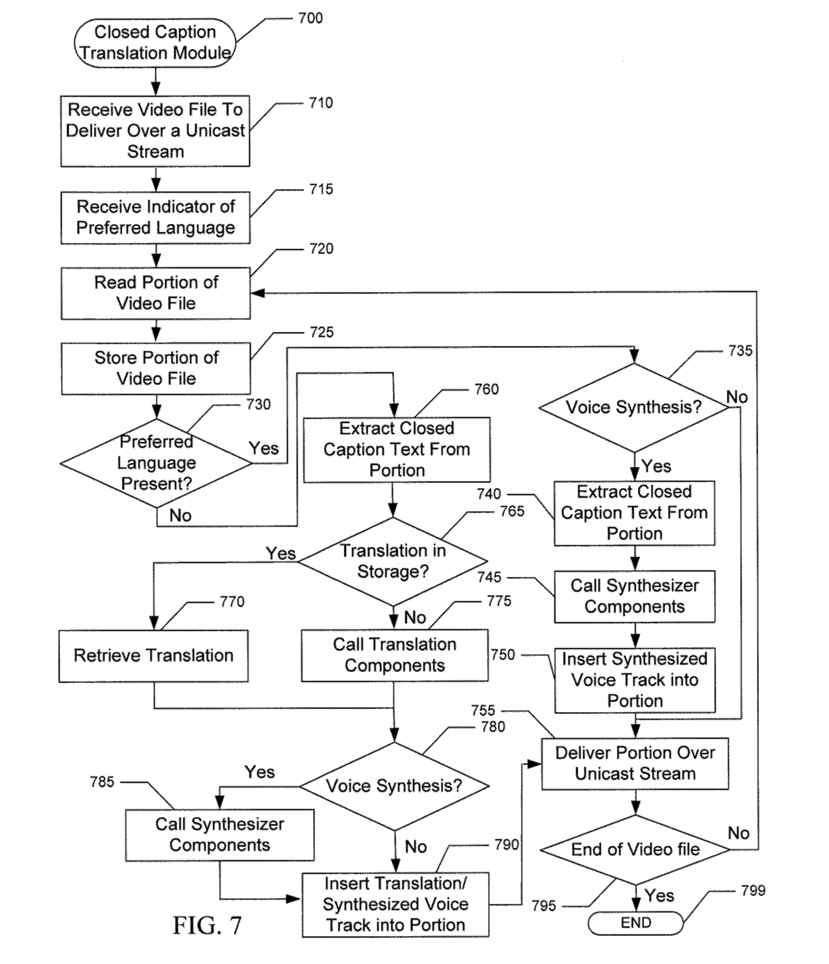

In various embodiments, the provider's system 200 includes a VOD application server 204. Furthermore, in various embodiments, the VOD application server 204 includes a closed caption translation module 700 that is configured to provide a selected video program to a viewer in the viewer's preferred language (e.g., provide the video program with closed caption text and/or a voice track in the viewer's preferred language). Accordingly, FIG. 7 illustrates a flow diagram of the closed caption translation module 700 according to various embodiments. This flow diagram may correspond to the steps carried out by the processor in the VOD application server 204 as it executes the module 700 in the server's 204 RAM memory according to various embodiments.

In various embodiments, the VOD application server 204 receives a request from the viewer to stream a particular video program to the viewer's set-top box 201 for viewing. The request may include different types of information according to various embodiments. For example, in one embodiment, the request includes an indicator for the selected program, an identifier of the particular viewer, and an identifier of the viewer's preferred language. In another embodiment, the request includes the indicator for the selected program and the identifier of the particular viewer. In this particular embodiment, the VOD application server 204 may retrieve the viewer's preferred language from a profile stored in a storage medium on the provider's system 200, such as the translation storage 207 shown in the system 200 depicted in FIG. 2.

In various embodiments, the VOD application server 204 retrieves a video file for the selected video program. For instance, in one-embodiment, the VOD application server 204 retrieves the video file from the VOD content storage 205 shown in the system 200 depicted in FIG. 2. The video file may be of various types of files. For example, in one embodiment, the video file is a MPEG file. At this point, in various embodiments, the VOD application server 204 invokes the closed caption translation module 700 to provide the selected video program in the viewer's preferred language. Thus, in Step 710, the closed caption translation module 700 receives the video file to deliver over a unicast stream to the viewer. Furthermore, in various embodiments, the closed caption translation module 700 receives the indicator of the viewer's preferred language, shown as Step 715.

In Step 720, the closed caption translation module 700 reads a portion of the video file. The portion of the video file can vary among embodiments. For instance, in one embodiment, the closed caption translation module 700 reads the first portion of the video file that includes enough of the file to determine what languages are present in the video file and to reach the first closed caption text to be translated. For example, the closed caption translation module reads enough of the file that includes metadata that indicates what closed caption languages are included in the video file.

In Step 725, the closed caption translation module 700 then stores at least a subset of the portion of the video file in memory (e.g., caches the portion of the video file in a buffer). In one embodiment, the memory may be volatile memory located on the VOD application server 204. In another embodiment, the memory may be non-volatile memory, such as the VOD content storage 205.

In Step 730, the closed caption translation module 700 determines whether the preferred language in already present in the video file. As previously mentioned, in various embodiments, the closed caption translation module 700 reads enough of the video file to include metadata that indicates what languages are present in video file. The closed caption translation module 700 compares what languages are present in the video file with the identifier of the viewer's preferred language. If the closed caption translation module 700 determines a match exists, the module 700 delivers the portion of the video file over the unicast stream to the viewer's set-top box 201 without having to process the portion of the video file further, shown as Step 755. The set-top box 201 receives the portion of the video file and provides a signal to the viewer's television for viewing the portion of the video.

In various embodiments, the closed caption translation module 700 then determines whether the module 700 has read the end of the video file, shown as Step 795. If the closed caption translation module 700 determines that the end of the video file has not been read, the module 700 returns to Step 720 and reads the next portion of the video file. This closed caption translation module 700 repeats this process until the entire video file has been streamed to the viewer's set-top box 201. As a result, the viewer is able to view the video program with closed caption text in the viewer's preferred language.

Furthermore, in various embodiments, the closed caption translation module 700 is configured to provide a voice track in the viewer's preferred language. Thus, in various embodiments, once the closed caption translation module 700 has determined that the preferred language is present in the portion of the video file, the closed caption translation module 700 determines whether the viewer has requested that a voice track be provided in the viewer's preferred language, shown as Step 735. For instance, in one embodiment, an indicator may be included with the viewer's request that indicates the viewer would like to receive a voice track in the viewer's preferred language. In another embodiment, the indicator may be stored in the viewer's profile and retrieved by the module 700.

If the closed caption translation module 700 determines the viewer does not wish to receive a voice track, the closed caption translation module 700 delivers the portion of the video file over the unicast stream to the viewer's set-top box 201, shown as Step 755. If the closed caption translation module 700 determines the viewer does wish to receive a voice track in the viewer's preferred language, the closed caption translation module 700 extracts the closed caption text from at least a subset of the portion of the video file, shown as Step 740. In various embodiments, the closed caption translation module 700 may carry out the extraction of the text by employing different techniques. For instance, in one embodiment, the closed caption translation module 700 may be configured to perform optical character recognition (OCR) on the portion of the video file if the closed caption text has been converted to graphic or raster text. In another embodiment, the text may be stored and in the MPEG stream in conventional text form and the closed caption translation module 700 extracts the text directly from the MPEG stream.

Next, in Step 745, the closed caption translation module 700 calls one or more text-to-voice synthesizer components present in the system 200 to convert the closed caption text to a voice track in the viewer's preferred language. For instance, in one embodiment, these components are located on the translation server 206 shown in the system 200 depicted in FIG. 2. The closed caption translation module 700 passes the closed caption text to the text-to-voice synthesizer components and receives back the voice track for the text in the viewer's preferred language.

As previously mentioned, the system 200 may incorporate any number of text-to-voice synthesizer components. For example, in one embodiment, the translation server 206 includes the Oki Semiconductor® MSM7630 processor that generates high-quality synthesized words for the closed caption text in the viewer's preferred language. Furthermore, in various embodiments, the text-to-voice synthesizer components may produce the voice track as digital audio data. For example, in particular embodiments, the text-to-voice synthesizer components produce the voice track as either MPEG audio data or AC3 audio data. Thus, the text-to-voice synthesizer components generate the voice track in the viewer's preferred language and pass the voice track to the closed caption translation module 700. In Step 750, the closed caption translation module 700 receives the voice track and inserts the voice track into the subset of the portion of the video file. For example, in one embodiment, the closed caption translation module 700 replaces the existing voice track with the voice track in the viewer's preferred language.

Finally, in Step 755, the closed caption translation module 700 delivers the portion of the video file over the unicast stream to the viewer's set-top box 201. As previously mentioned, the closed caption translation module 700 determines whether the end of the video file has been read (shown as Step 795), and if not, the closed caption translation module 700 returns to Step 720 and reads the next portion of the video file and repeats the steps to deliver the next portion of the video file over the unicast stream with a voice track in the viewer's preferred language. The closed caption translation module 700 repeats this process until the end of the video file has been read.

Returning back to Step 730 in which the closed caption translation module 700 determines whether the portion of the video file already has the preferred language, this time the closed caption translation module 700 determines the preferred language is not present in the portion of the video file. Thus, the module 700 extracts the closed caption text from at least a subset of the portion of the video file, shown as Step 760.

In various embodiments, the provider's system 200 may also store various translations for the available VOD content. For instance, in one embodiment, the system 200 stores the translations in the translation storage 207 shown in the system 200 depicted FIG. 2. Thus, in these particular embodiments, the closed caption translation module 700 determines whether a translation is stored in the system 200 in the viewer's particular language, shown as Step 765.

If the translation is available for the particular program in the storage 207, the closed caption translation module 700 retrieves the translation from the storage 207, shown as Step 770. For instance, in one embodiment, the closed caption translation module 700 queries the storage 207 based on the preferred language identifier. If the query indicates a translation is available, the closed caption translation module 700 then retrieves the translation from the storage 207.

If the translation is not available for the particular program in the storage 207, the closed caption translation module 700 calls one or more translation components to have the extracted closed caption text translated to the viewer's preferred language, shown as Step 775. Thus, the closed caption translation module 700 forwards the closed caption text and the preferred language identifier to the translation components and the translation components return the closed caption text translated into the viewer's preferred language to the closed caption translation module 700.

In various embodiments, the translation components may be located within the provider's system 200. For example, the translation components may be located on the translation server 206 shown in the system 200 depicted in FIG. 2. Furthermore, the translation components may include any type of available text translation components. For example, in one embodiment, the translation components may include translation software such as Babylon®, Systran®, or Promt®. As a result of using such software, a translation of the closed caption text is provided in the viewer's preferred language and in an appropriate character set for the language.

In Step 780, the closed caption translation module 700 determines whether the viewer would also like to have a voice track in the viewer's preferred language. If the closed caption translation module 700 determines that the viewer would like a voice track, the module 700 calls the text-to-voice components, shown as Step 785. In turn, the text-to-voice synthesizer components generates the voice track for the translated closed caption text in the viewer's preferred language and returns the voice track to the closed caption translation module 700.

Thus, in Step 790, the closed caption translation module 700 inserts the translations into the portion of the video file. For instance, in one embodiment, the closed caption translation module 700 inserts both the translated closed caption text and the voice track into the subset. In another embodiment, the closed caption translation module 700 only inserts the translated closed caption text in the subset. Yet, in another embodiment, the closed caption translation module 700 only inserts the voice track into the subset.

Once the closed caption translation module 700 has inserted the translated closed caption text and/or the voice track into the portion of the video file, the module 700 delivers the portion of the video file over the unicast stream to the viewer's set-top box 201. In turn, the set-top box 201 generates a signal from the streamed portion of the video file to display on the viewer's television and to produce sound from the voice track. As a result, the viewer is able to watch the program with closed caption text in the viewer's preferred language and/or watch the program and listen to the program in the viewer's preferred language.

In Step 795, the closed caption translation module 700 determines whether the module 700 has read to the end of the video file. If the closed caption translation module 700 determines that it has not read to the end of the file, the closed caption translation module 700 returns to Step 720 and reads the next portion of the file. The closed caption translation module 700 then follows through the same logic as discussed above and delivers the next portion of the video file with translated closed caption text and/or a voice track in the viewer's preferred language. In various embodiments, this process is repeated until the closed caption translation module 700 reaches the end of the video file at which point the process ends at Step 799.

As a result of the closed caption translation module 700 following this logic, the viewer is able to watch the selected video program in his or her preferred language. Furthermore, in various embodiments, the closed caption translation module 700 provides the program over a unicast stream to the individual viewer. Therefore, as a result, the closed caption translation module 700 of various embodiments is configured to provide any number of languages to any number of VOD subscribers (or users). For instance, in one embodiment, the closed caption translation module 700 can provide a movie with French closed caption text over a first unicast stream to a first viewer, the same movie with German closed caption text over a second unicast stream to a second viewer, and the same movie with Spanish closed caption text over a third unicast stream to a third viewer, all at the same time.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

What is claimed is:

1. A system for providing a selected video program in a preferred language to a viewer comprising:
memory;
a closed caption translation module; and
at least one computing device configured to execute the closed caption translation module to:
(a) receive a video file of the selected video program to deliver to the viewer over a unicast stream;
(b) receive an indicator of the preferred language;
(c) read a portion of the video file;
(d) store at least a subset of the portion of the video file in the memory;
(e) extract closed caption text from the subset of the portion of the video file;
(f) obtain a translation of the closed caption text in the preferred language;
(g) insert the translation into the subset of the portion of the video file; and
(h) deliver the subset of the portion of the video file comprising the translation over the unicast stream, wherein the subset of the portion of the video file provides a signal for displaying an image of the selected video program with the translation of the closed caption text in the preferred language to the viewer.

2. The system of claim 1, wherein the at least one computing device is configured to execute the closed caption translation module to repeat (c) through (h) until the closed caption translation module has read a final portion of the video file.

3. The system of claim 1, wherein the video file comprises an MPEG file.

4. The system of claim 1 further comprising a set-top box configured to:
send an indicator of the selected video program over a network;
receive the subset of the portion of the video file streamed in the unicast stream over the network; and
generate the signal for displaying the image of the selected video program with the translation of the closed caption text in the preferred language to the viewer.

5. The system of claim 4, wherein the set-top box is further configured to send the indicator of the preferred language over the network to the computing device, wherein the preferred language is identified by the viewer.

6. The system of claim 1, wherein the indicator of the preferred language is stored in a viewer profile in a storage device and the viewer profile is associated with the viewer.

7. The system of claim 1 further comprising a text translation component configured to translate the closed caption text into the preferred language in order to provide the translation of the closed caption text.

8. The system of claim 1, wherein the closed caption translation module obtains the translation of the closed caption text in the preferred language from a storage device.

9. The system of claim 1 further comprising a text-to-voice synthesizer component that are configured to:
receive the translation; and
generate a synthesized voice track in the preferred language based on the translation; and
the at least one computing device is configured to execute the closed caption translation module to:
insert the synthesized voice track into the subset of the portion of the video file, wherein the at least one computing device inserts the subset of the portion of the video file comprising the synthesized voice track into the unicast stream and the subset of the portion of the video file comprising the synthesized voice track is streamed to the viewer to provide a signal for displaying an image of the selected video program in the preferred language and for producing sound from the synthesized voice track in the preferred language.

10. The system of claim 9, wherein the synthesized voice track comprises MPEG audio data or AC3 audio data.

11. A method for providing a selected video program in a preferred language to a viewer, the method comprising the steps of:
(a) receiving a video file of the selected video program from a storage device to deliver to the viewer over a network in a unicast stream;
(b) receiving an indicator of the preferred language at the computer device;
(c) reading a portion of the video file by using the computing device;
(d) storing at least a subset of the portion of the video file in memory of the computing device;
(e) extracting closed caption text from the subset of the portion of the video file by using the computing device;
(f) obtaining a translation of the closed caption text in the preferred language from a translation component;
(g) inserting the translation into the subset of the portion of the video file by using the at least one computing device; and
(h) delivering the subset of the portion of the video file comprising the translation over the network in the unicast stream to the viewer's set-top box, wherein the subset of the portion of the video file provides a signal for displaying an image of the selected video program with the translation of the closed caption text in the preferred language to the viewer.

12. The method of claim 11, wherein the Steps (c) through (h) are repeated until a final portion of the video file has been read.

13. The method of claim 11, wherein the video file comprises an MPEG file.

14. The method of claim 11 further comprising the steps of:
receiving an indicator of the selected video program over the network sent from the set-top box; and
receiving the indicator of the preferred language over the network sent from the set-top box, wherein the preferred language is identified by the viewer.

15. The method of claim 11, wherein the step of receiving the indicator of the preferred language comprises retrieving the indicator from a viewer profile associated with the viewer stored in the storage device.

16. The method of claim 11, wherein the step of obtaining the translation of the closed caption text in the preferred language is performed by retrieving the translation from the storage device.

17. The method of claim 11 further comprising the steps of:
generate a synthesized voice track in the preferred language based on the translation by utilizing a text-to-voice synthesizer component;
inserting the synthesized voice track into the subset of the portion of the video file; and
delivering the subset of the portion of the video file comprising the synthesized voice track over the network in the unicast stream to the viewer's set-top box, wherein the subset of the portion of the video file provides a signal for displaying an image of the selected video program in the preferred language and for producing sound from the synthesized voice track in the preferred language.

18. The method of claim 17, wherein the synthesized voice track comprises MPEG audio data or AC3 audio data.

19. A computer-readable medium containing code executable by a processor for providing a selected video program in a preferred language to a viewer comprising at least one component adapted for:
(a) receiving a video file of the selected video program to deliver to the viewer over a unicast stream;
(b) receiving an indicator of the preferred language;
(c) reading a portion of the video file;
(d) storing at least a subset of the portion of the video file in memory;
(e) extracting closed caption text from the subset of the portion of the video file;
(f) obtaining a translation of the closed caption text in the preferred language;
(g) inserting the translation into the subset of the portion of the video file; and
(h) delivering the subset of the portion of the video file comprising the translation over the unicast stream to the viewer, wherein the subset of the portion of the video file provides a signal for displaying an image of the selected video program with the translation of the closed caption text in the preferred language to the viewer.
